(19) United States
(12) Patent Application Publication
(10) Pub. No.: US 2008/0276787 A1
(43) Pub. Date: Nov. 13, 2008

(54) Device for Automatically Tuning a String of a Stringed Instrument

(76) Inventor: Christopher Adams, Hamburg (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/908,582

(22) PCT Filed: Mar. 17, 2005
(86) PCT No.: PCT/EP05/02852

§ 371 Date: Mar. 14, 2008

(51) Int. Cl. G10D 3/14; G10G 7/02

(52) U.S. Cl. 84/304; 84/454

(57) ABSTRACT

A device is disclosed for tuning at least one string of a string instrument, preferably a guitar, in particular an electric guitar or a bass, in particular an electric bass, comprising a detection device for detecting a note generated by striking a string and for output of a signal corresponding to the note detected, a memory device for storing preselected signals, corresponding to a desired note, a comparator device for comparing the signal output by the detection device with a signal corresponding to the desired note and stored in the memory device, an adjusting device for varying the tension of at least one of the strings, at least one drive for driving the adjusting device, a controller connected to the comparator device and controlling the at least one drive via a control line on the basis of a deviation found in the comparator device between the signals representing the note thereby generated and signals representing the desired note.

To design such a device so that it can be integrated into an instrument, in particular a guitar or a bass with a minimal influence on the sound properties and with the smallest possible number of elements that are also as small as possible and nevertheless allow variable design options, it is proposed that the detection device should be a piezoelectric pickup arranged directly on the adjusting device.

### CROSS-REFERENCE TO RELATED APPLICATION

This application is a national stage of and claims the benefit of priority of International Patent Application No. PCT/EP2005/002852, filed on Mar. 17, 2005, which is relied on and incorporated herein by reference.

### BACKGROUND OF THE INVENTION

The present invention relates to a device for automatic tuning at least one string of a string instrument, preferably a guitar, in particular an electric guitar, or a bass, preferably an electric bass.

Tuning of instruments in general requires not only a trained ear but also a certain amount of time which must be spent in particular by untrained players, e.g., hobby instrumentalists. In the traditional method of tuning “by hand,” the musician works with a tuning fork which produces the desired note when struck and adjusts the note position of the respective string by changing the length of the string and/or the tension on the string. The result is adjusted by repeated striking of the string and the tuning fork until achieving the desired tuning of the string. Based on this tuning, the other strings are then also tuned.

The strings of a string instrument must be tuned regularly because the material of the strings is constantly yielding, but on the other hand, the strings have a variable length which depends on climate conditions (for example, a guitar string stretches due to heat and humidity on the stage of a concert hall in comparison with the conditions in a comparatively dry and cool practice room), which thus necessitates frequent tuning. Further, after new strings are tightened, they must be tuned.

To relieve this situation somewhat, U.S. Pat. No. 4,803,908 has proposed a device for automatic tuning of at least one string of a string instrument, preferably a guitar, in particular an electric guitar, or a bass, preferably an electric bass. With this device, all the strings on a guitar are struck simultaneously with an auxiliary means arranged in the body of the guitar and referred to as a “strummer” there. An electronic device detects the sounds, compares them with the ideal standard and controls an adjusting device that acts on the strings to adjust the string tension in such a manner that it hits the specified notes.

This system is to be welcomed inasmuch as it allows rapid and automatic tuning and thus reduces a great deal of the effort required not only by unskilled musicians but also by professional musicians. However, this system has a significant disadvantage. It is large and clumsy on the whole and requires considerable modifications to the body of the guitar, which in turn influence the acoustics (sound) while also affecting handling (because of the change in weight).

Apart from this fact, the visual appearance of the guitar is also altered in a significant manner.

Since the guitar as a whole forms the resonant body which has a significant influence on the sound properties, the sound properties therefore also change when the resonant body is changed. Therefore, existing instruments are virtually impossible to retrofit with the system known in the past, but it is also very difficult to integrate it into new guitars. Specifically two types of guitars would have to be developed independently of one another in the design stage from the standpoint of sound, one guitar with the previously known device and another without it.

The present invention begins with the problems described here. The object of the present invention is to provide an improved device inasmuch as it can be integrated into an instrument, in particular a guitar or a bass, while having a minimal effect on the sound properties and using the smallest possible number of the smallest possible elements. In particular the device should be designed by the modular principle and should be variable accordingly.

This object is achieved by means of a device for automatic tuning of at least one string of a string instrument, preferably a guitar, in particular an electric guitar, or a bass, preferably an electric bass. Advantageous embodiments of the device are characterized in that the adjusting device is a tuning mechanism provided on the head of a guitar, in particular an electric guitar, and/or a bass, in particular an electric bass, having a peg and a thumbscrew for adjusting the peg, and the piezoelectric pickup is arranged directly on the tuning mechanism.

The basic idea of the present invention is to use a piezoelectric pickup as the detection device or sensor element for detecting the sound generated by a string when it is struck, said piezoelectric pickup being arranged directly on the control device. Piezoelectric pickups are structure born sound sensors which pick up the sound transmitted in solid bodies and convert it to an electric signal. Such piezoelectric pickups can be manufactured as particularly small elements. The advantage of using piezoelectric pickups that are arranged directly on the adjusting device is that they can be arranged in a space-saving and “unnoticeable” position on the string instrument. For example, it is known that an arrangement with piezoelectric pickups may be clamped to the neck of a guitar. This arrangement is visually disturbing and is comparatively inaccurate because the piezoelectric pickups are not connected directly to a body which is in turn in direct contact with the vibrating string but instead the sound waves are picked up across an air gap between the string and the piezoelectric pickup. For a highly precise and accurate determination of the sound produced by the string that has been struck, such a piezoelectric pickup mounted in this way is not accurate enough. The situation is different with the inventive arrangement directly on the adjusting device. The string typically runs directly to the adjusting device and is in direct physical contact with it. Thus the sound of the vibrating string here is transmitted directly and precisely to the body of the adjusting device and can be picked up accurately by the piezoelectric pickup arranged directly on it.

Furthermore, an arrangement of the piezoelectric pickup directly on the adjusting device of the string instrument offers the possibility of designing the inventive device as a modular unit for automatic tuning of the string instrument. For example, the adjusting device may be located anywhere on one of the secured ends of the strings, with the detection of the sound created by the vibrating string taking place at precisely this end. The other elements of the inventive device may then also all be arranged on this end of the string or they may be partially or entirely arranged on the other end of the strings.

On the example of a guitar, in particular an electric guitar, and/or a bass, in particular an electric bass, this means for example that the adjusting device may consist for example of the tuning mechanisms each of which is provided with a peg and a thumbscrew for adjusting the peg and the piezoelectric pickup may be arranged directly on at least one of the tuning mechanisms. In the case of the aforementioned musical instruments, these tuning mechanisms are situated on the head, which usually offers very little space for the placement of other elements. On the basis of the example of such an instrument, the modular design of the inventive device which is possible in principle is now such that some or all of the additional elements of the device may be placed on the body of the instrument, in which case then it is necessary to ensure that control signals as well as a voltage supply must be carried from the body to the head of the instrument for triggering at least one adjusting device and/or for driving it. This may be accomplished for example by utilizing the strings as current carrying elements.

The piezoelectric pickup may be countersunk into the adjusting device, e.g., screwed in or pressed in place or glued to it. This is of course true not only of the adjusting device in the form of the tuning mechanisms but also other adjusting devices into which the piezoelectric pickups can be countersunk or onto which the piezoelectric pickups can be glued.

According to another advantageous embodiment of the inventive device, the drive for driving the adjusting devices in the form of tuning mechanisms may be formed by one or more motors. One or more motors may drive several of the pegs via a shiftable gear and flexible shafts connected in between or a separate motor may be provided for each peg.

A further advantageous embodiment according to which the controller with the comparator device is also arranged with the comparator device on the head of the guitar or bass.

Likewise, a power source may also be provided for supplying power to at least some of the components of the device on the head of the guitar and/or bass.

In addition to the function as a detection device for the device for automatic tuning of the string instrument, the piezoelectric pickups may additionally fulfill other functions. A preferred embodiment according to which the signals picked up by the piezoelectric pickups may also be used as control signals, e.g., as MIDI signals. It is also conceivable for the signals of the piezoelectric pickups to be used for acoustic playback of the sound of the string instrument in which case they are sent to an amplifier. For example in the case of an electric guitar or an electric bass, this yields the possibility of creating a sound of the instrument that is altered in comparison with a pickup using so-called electromagnetic pickups. If the piezoelectric pickups are additionally used in one of the ways described above, one need only supply signal lines with which the signals detected by the piezoelectric pickups are sent to a corresponding electric output of the instrument.

An adjusting device is preferably provided on each string of the string instrument and a piezoelectric pickup is mounted directly on each of the adjusting devices.

Essentially it is also conceivable to use the piezoelectric pickups provided according to this invention directly on an adjusting device in a device not intended for automatic tuning of a guitar but instead intended merely as a tuning aid. The drive for adjusting the control mechanism would lack such a device and instead the control would be connected to a display representing a deviation from the ideal note, e.g., an LED display or a pointer display. Such a display may also be provided with a device for automatic tuning of an instrument such as that described and claimed here.

### BRIEF DESCRIPTION OF THE DRAWINGS

Additional advantages and features of the present invention are derived from the following description of an exemplary embodiment on the basis of the accompanying figures. The present invention is explained in the exemplary embodiment on the basis of an implementation in an electric guitar. However, the present invention is not limited to this instrument but instead may also be used with any other string instruments.

In the figures:

FIG. 1 shows a schematic view of an electric guitar,

FIG. 2 shows a three-dimensional schematic view of an individual tuning mechanism of an electric guitar with a piezoelectric pickup glued to it and with a connection for a driveshaft of a drive motor,

FIGS. 3a and 3b shows an alternative embodiment of a tuning mechanism equipped with a piezoelectric pickup in which the piezoelectric pickup is countersunk into the tuning mechanism, namely being pressed into it in a conical form in this exemplary embodiment,

FIG. 4 shows a possible arrangement of a drive formed by two motors and a gear for the peg on the head of the electric guitar and

FIG. 5 shows a sectional diagram along section line IV-IV from FIG. 4.

The figures show the same or similar elements labeled with the same reference numerals.

### DETAILED DESCRIPTION OF THE INVENTION

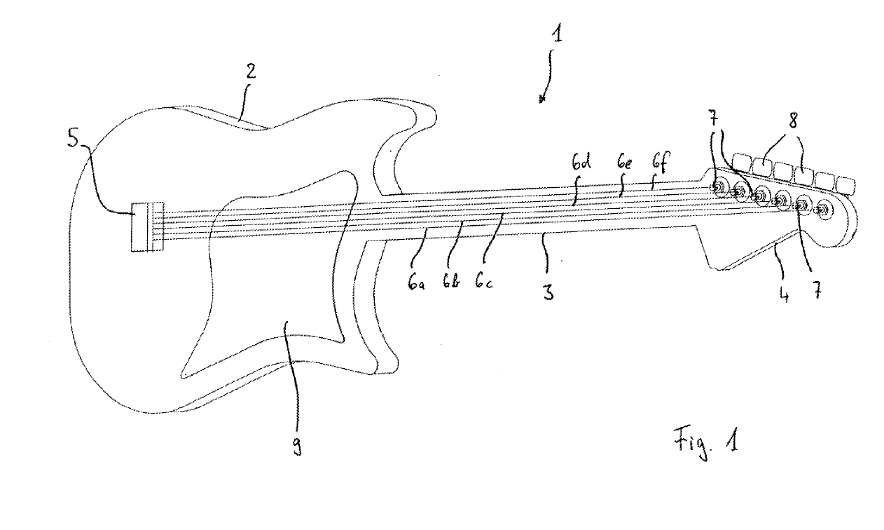

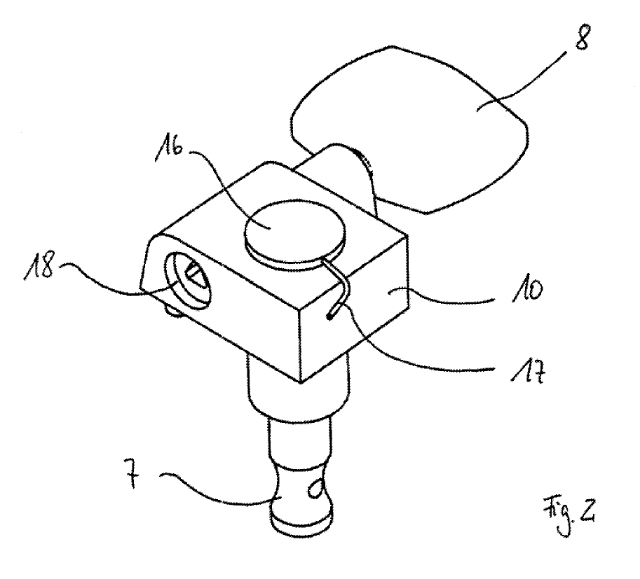

FIG. 1 shows schematically an electric guitar 1 as an example of a string instrument on which the inventive device may be implemented. It can be subdivided approximately into a body 2, a neck 3 and a head 4. A mounting block 5, in this case a tremolo system block, is mounted on the body 2 with the six strings 6a through 6f of the guitar 1 being attached to this block with their first ends. The strings 6a through 6f extend from here along the body 2, the neck 3 to the head 4 where they are wound onto pegs 7 of the tuning mechanisms 10 arranged on the head 4 (see FIGS. 2, 3a, 3b, 4 and 5). To adjust the pegs 7, thumbscrews 8 are provided on the tuning mechanisms 10. A so-called pickguard 9 is provided on the body 2 of the electric guitar 1 beneath the strings 6a through 6f.

In this example, the adjusting mechanisms are formed by the tuning mechanisms 10.

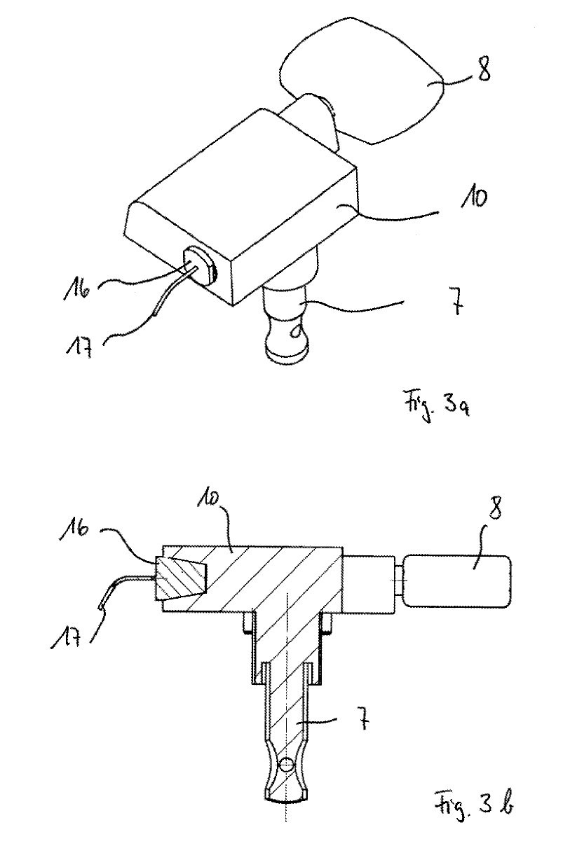

FIGS. 2, 3a and 3b show how piezoelectric pickups 16 are arranged directly according to this invention on these adjusting devices, i.e., on the tuning mechanisms 10. FIGS. 2 and 3a and 3b illustrate two different variants of the possible direct mounting of the piezoelectric pickup 16 on the tuning mechanisms 10. In the example shown in FIG. 2, the piezoelectric pickup 16 is glued to an element of the tuning mechanism 10. In the example shown in FIGS. 3a and 3b, the piezoelectric pickup 16 is countersunk into a part of the tuning mechanism 10, namely being pressed there in the present case. This is shown especially clearly in the sectional diagram in FIG. 3b. In the latter example the piezoelectric pickup 16 has a conical shape and is pressed into a receptacle having a complementary shape accordingly in the tuning mechanism. A signal line 17 of the piezoelectric pickup 16 relays the audio signals picked up by the piezoelectric pickup 16 to the comparator device or the controller.

FIG. 2 further shows a connection 18 for connecting a shaft that is or can be connected to a drive namely a motor 15 in this example. Such a connection is in principle also present in the exemplary embodiment shown in FIGS. 3a and 3b but is not shown in detail there.

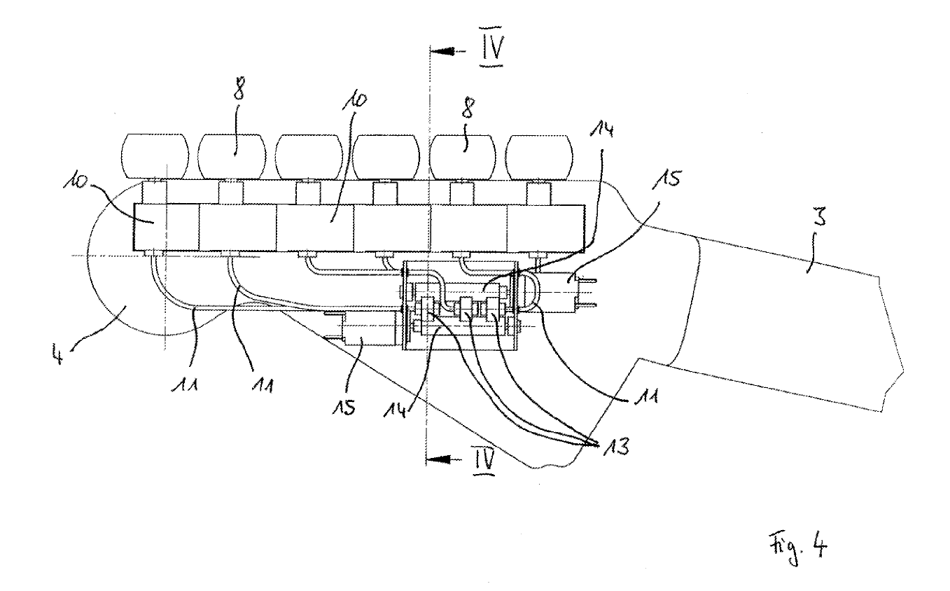

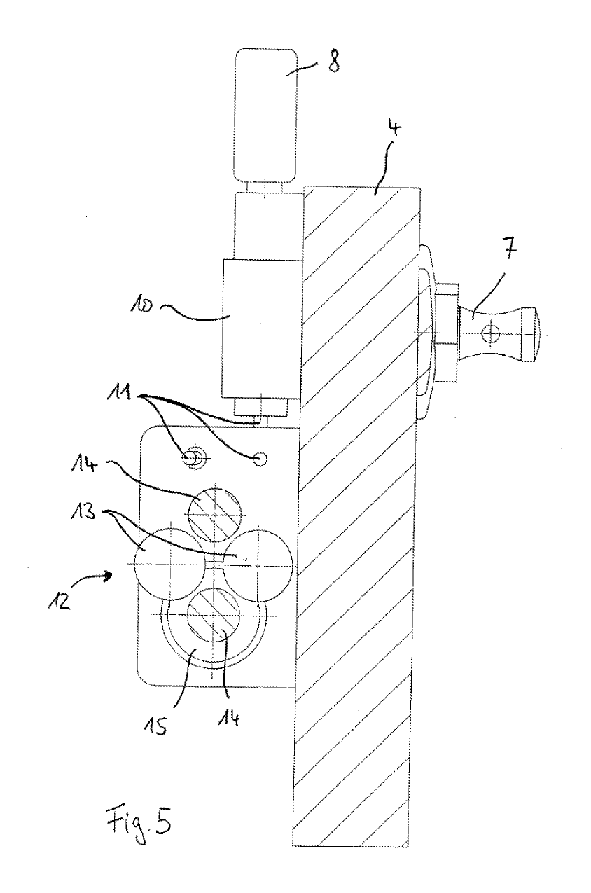

FIGS. 4 and 5 illustrate one possible arrangement of drive motors 15 for driving the tuning mechanisms 10. Two drive motors 15 are arranged here so they are opposite one another in mirror image. The drive motors 15 run in the same direction, transmitting their drive force directly to a drive roller 14 assigned to the respective motor 15. In the area of the drive rollers 14, take-up wheels 13 are provided and can optionally be engaged with one of the drive rollers 14. To do this the surfaces of the driver rollers 14 and the take-up wheels 13 are preferably made of rubber to achieve the highest possible friction and thus a transfer of the respective torque. On the whole six take-up wheels 13 are provided, only three of them discernible in FIG. 4. The three other take-up wheels are situated beneath the plane of the drawing in FIG. 4, beneath the take-up wheels 13 shown there. Each of the take-up wheels 13 is connected to a flexible shaft 11 which leads to the connection 18 in the respective tuning mechanism 10.

The inventive device for automatic tuning of the electric guitar 1 shown here functions as described below.

First, the guitar is switched to a tuning mode, e.g., by operating a corresponding switch. Then at least one of the strings to be tuned is struck. The resulting sound, e.g., the resulting note is transmitted to the tuning mechanism 10 via the end of the string being wound onto the respective peg 7 of the respective tuning mechanism 10. The piezoelectric pickup 16 arranged directly on the tuning mechanism 10 picks up the sound signal and relays it to a comparator device (not shown) over the signal line 17. The comparator device is preferably also arranged on the head 4 of the electric guitar 1. The note actually detected is compared in the comparator device, e.g., on the basis of the frequency, with an ideal value stored in a memory device (also not shown here), preferably likewise arranged on the head 4 of the guitar 1. The deviation is relayed to a controller (also not shown here) which is preferably arranged on the head 4 of the electric guitar 1. On the basis of this deviation, the controller determines the direction in which the string is to be moved (tightening or relaxing the string). Then the controller delivers a corresponding signal to the unit shown in FIGS. 4 and 5 consisting of the motors 15 and the gear formed by the take-up wheels 13 and the driver rollers 14, so that the take-up wheel 13 assigned to the tuning mechanism 10 onto which the string to be tuned is wound is pressed against one of the drive rollers 14, depending on the direction of adjustment of the strike, and the respective motor 15 is turned on.

Torque is transmitted to the tuning mechanism 10 via the flexible shaft 11 connected to the corresponding take-up wheel 13, and then finally is transmitted to the peg 7 so that the string tension is varied. This also changes the frequency of the note produced by the string, which in turn is picked up by the piezoelectric pickup 16 and sent to the comparator device. Only when the comparator device finds a match between the value detected and the ideal value does the controller control the motors 15 and the gear, consisting of the take-up wheels 13 and the drive rollers 14, to suppress any further change in the string tension.

### LIST OF REFERENCE NUMERALS

1 electric guitar
2 body
3 neck
4 head
5 tremolo system block
6a-f string
7 peg
8 thumbscrew
9 pickguard
10 mechanism
11 flexible shaft
12 gear
13 take-up wheel
14 drive roller
15 motor
16 piezoelectric pickup
17 signal line
18 connection

1-9. (canceled)

10. A device for tuning at least one string of a string instrument comprising:
a) a detection device for detecting a note created by striking the string and for outputting a signal corresponding to the note detected;
b) a memory device for storing preselected signals which correspond to a desired note;
c) a comparator device for comparing the signal output by the detection device with a signal that corresponds to the desired note and is stored in the memory device;
d) an adjusting device for varying the tension of at least one of the strings, wherein the detection device is a piezoelectric pickup arranged on the adjusting device;
e) at least one drive for driving the adjusting device; and
f) a controller which is connected to the comparator device and which controls the at least one drive via a control line based on a deviation found in the comparator device between the signals representing the note generated and the signal representing the desired note.

11. The device according to claim 10, wherein the adjusting device is a tuning mechanism provided on the head of a guitar having a peg and a thumbscrew for adjusting the peg, and the piezoelectric pickup is arranged directly on the tuning mechanism.

12. The device according to claim 11, wherein the piezoelectric pickup is glued to a part of the tuning mechanism.

13. The device according to claim 11, wherein the piezoelectric pickup is countersunk in a portion of the tuning mechanism and/or is screwed or pressed therein.

14. The device according to claim 11, wherein the drive is formed by at least one motor arranged on the head of the guitar, said motor being connected to the adjusting device for driving the adjusting device.

15. The device according to claim 11, wherein the controller is arranged with the comparator device on the head of the guitar.

16. The device according to claim 11, wherein a power source for supplying power to at least a portion of the components of the device is provided on the head of the guitar.

17. The device according to claim 10, wherein an output of the piezoelectric pickup is configured to enable signals picked up to also be used as control signals.

18. The device according to claim 10, wherein an adjusting device is provided for each string of the string instrument, and a piezoelectric pickup is arranged directly on each of the adjusting devices.

19. The device according to claim 10, wherein an output of the piezoelectric pickup is configured to enable signals picked up to also be used as MIDI signals.
